(19) United States
(12) Patent Application Publication
(10) Pub. No.: US 2003/0118880 A1
(43) Pub. Date: Jun. 26, 2003

(54) Evaporative edge cooling of a fuel cell

(75) Inventors: Joerg Zimmerman, Vancouver (CA); Olen R. Vanderleeden, Coquitlam (CA); Leslie Bartha, North Vancouver (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems, Burnaby (CA)

(21) Appl. No.: 10/303,638

(22) Filed: Nov. 25, 2002

Related U.S. Application Data
(60) Provisional application No. 60/333,798, filed on Nov. 28, 2001.

(51) Int. Cl. H01M 8/04

(52) U.S. Cl. 429/13; 429/26; 429/25

(57) ABSTRACT

A method and apparatus for cooling an electrochemical fuel cell which comprises coolant channels extending along the edge of the fuel cell, adjacent to the active area whereby the fuel cell is cooled by evaporating a liquid coolant in the coolant channels. The coolant may then be condensed and recirculated through the coolant channels. Efficient cooling of the fuel cell may be enhanced by reducing the boiling point of the coolant by reducing the pressure across the coolant channels.

### CROSS-REFERENCE TO RELATED APPLICATION

This application claims the benefit of U.S. Provisional Patent Application No. 60/333,798 filed Nov. 28, 2001, which provisional application is incorporated herein by reference in its entirety.

### BACKGROUND OF THE INVENTION

1. Field of the Invention

This invention relates generally to compact cooling of electrochemical fuel cells. More specifically, the present invention relates to a method and apparatus for evaporative cooling along at least one edge of an electrochemical fuel cell.

2. Description of the Related Art

Electrochemical fuel cells convert fuel and oxidant to electricity and reaction product. Solid polymer electrochemical fuel cells generally employ a membrane electrode assembly (“MEA”) comprising a solid polymer electrolyte or ion exchange membrane interposed between two electrodes. Each electrode includes electrocatalyst material, defining an electrochemically active area, to induce the desired electrochemical reaction in the fuel cell. The electrodes are electrically coupled to provide a path for conducting electrons between the electrodes through an external load.

At the anode, the fuel stream moves through the anode fluid distribution layer and is oxidized at the anode electrocatalyst. At the cathode, the oxidant stream moves through the cathode fluid distribution layer and is reduced at the cathode electrocatalyst. Collectively, such distribution layers are typically referred to as reactant field flow plates. The ion exchange membrane conducts ions from one electrode to the other and substantially isolates the fuel stream on the anode side from the oxidant stream on the cathode side.

Two or more fuel cells can be connected together, generally in series, but sometimes in parallel, to increase the overall power output of the assembly. Fuel cells are commonly electrically connected in series in fuel cell stacks by stacking individual fuel cell assemblies. In such series connected fuel cell stacks, one side of a given separator plate can serve as an anode plate for one cell and the other side of the plate can serve as the cathode plate for the adjacent cell. The separator plate is thus a bipolar plate.

The electrochemical reaction that occurs in a fuel cell is generally exothermic and systems are provided for controlling the temperature of the fuel cell. In conventional solid polymer fuel cell stacks, cooling of the fuel cells is typically accomplished by providing cooling layers disposed between adjacent pairs of stacked fuel cells. Often the cooling layer is similar in design to a reactant flow field plate wherein a coolant, typically water, is fed from an inlet manifold and directed across the cooling plate in channels to an outlet manifold. This type of fuel cell stack typically requires three plates between each adjacent MEA, namely an anode plate, a cathode plate and a cooling plate. The coolant channels thus superpose the active area of the fuel cell. In operation, heat generated in the fuel cells is drawn away from each fuel cell by the coolant through the thickness of the plates perpendicular to the plane of the fuel cell assemblies. Heat is then transferred to and carried away by a circulating coolant. Cooling with an additional coolant layer can be called “interstitial” cooling. However, interstitial cooling may add significantly to the height of the stack and consequently lead to low packing densities. Increasing the packing density is particularly important for applications requiring low weight, low volume and high power density.

An alternative approach to cooling a fuel cell as disclosed in, for example, published PCT WO 01/54218 is a heat radiating fin extending outward from the main body of the fuel cell. Typically, fin based cooling systems do not provide enough heat removal for use with higher power densities. To improve the heat removal capabilities, external fins may be large and bulky, thereby resulting in low packing densities. As a further alternative, U.S. Pat. No. 5,804,326 (incorporated herein by reference in its entirety) avoids interstitial cooling and discloses an integrated reactant and coolant fluid flow field layer for an electrochemical fuel cell. While high packing densities may be obtained using the integrated reactant and coolant fluid flow field layer, the cooling may not be adequate for some fuel cell systems.

Accordingly, there continues to be a need for efficient cooling of a fuel cell while still allowing high packing densities.

### BRIEF SUMMARY OF THE INVENTION

A method and apparatus for cooling an electrochemical fuel cell which comprises coolant channels situated along the edge of electrodes in the fuel cell, adjacent to the electrochemically active area. The coolant is selected such that it has a boiling point below the operating temperature of the fuel cell. As the coolant is directed into the coolant channels, the coolant evaporates from the heat generated by the fuel cell. Evaporative cooling increases the efficiency of the cooling system and having the coolant channels situated along an edge adjacent to the active area of the fuel cell, instead of in a separate coolant layer that superposes the active area, allows greater packing densities. Further, evaporative cooling allows effective cooling with smaller channels than typically needed in conductive cooling systems.

The evaporated coolant may then be fed through a coolant condenser fluidly connected to the coolant outlet of the coolant channels such that the evaporated coolant condenses. A pump, fluidly connected to both the coolant inlet and the coolant outlet can then recirculate the condensed coolant back into the coolant channel. Recirculation of the liquid coolant allows for continuation operation of the fuel cell with the minimum of coolant needed to be stored within the system.

In another embodiment, the pressure in the coolant channel is varied, thereby varying the boiling point of the coolant. This may allow more efficient coolant across a greater range of operating temperatures of the fuel cell and/or different coolants to be used. The pump used to circulate the liquid coolant through the coolant channels may be used to vary the pressure in the coolant channels.

Various embodiments of the fuel cell or fuel cell stack can accommodate edge cooling. For example, the coolant channels can extend along the edge of individual fuel cells, oriented in substantially the same plane as the active area. Alternatively, in a fuel cell stack, the coolant may flow in channels that extend along the edge of the fuel cell stack, oriented substantially perpendicular to the planes defined by the active areas.

### BRIEF DESCRIPTION OF THE SEVERAL VIEWS OF THE DRAWINGS

FIG. 1 is a sectional view of a portion of a fuel cell stack showing coolant channels along the edges of the fuel cell, fluidly isolated from the reactant channels.

FIG. 2 is a simplified schematic of evaporative edge cooling system for use in a fuel cell assembly wherein the evaporated coolant is condensed and recirculated back to the fuel cell.

FIG. 3 is an exploded isometric view of a portion of a fuel cell with coolant channels extending along the length of a fuel cell edge, adjacent to the active areas of the fuel cell.

FIG. 4 is an exploded isometric view of a portion of a fuel cell with coolant channels extending along the length of a fuel cell and along the center, bisecting the active areas of the fuel cell and thereby running along the edge of the active area.

FIG. 5 is a partially exploded, schematic, isometric view of a fuel cell stack with coolant channels extending through the stack substantially perpendicular to the major planar surfaces of the stacked assemblies.

### DETAILED DESCRIPTION OF PREFERRED EMBODIMENTS

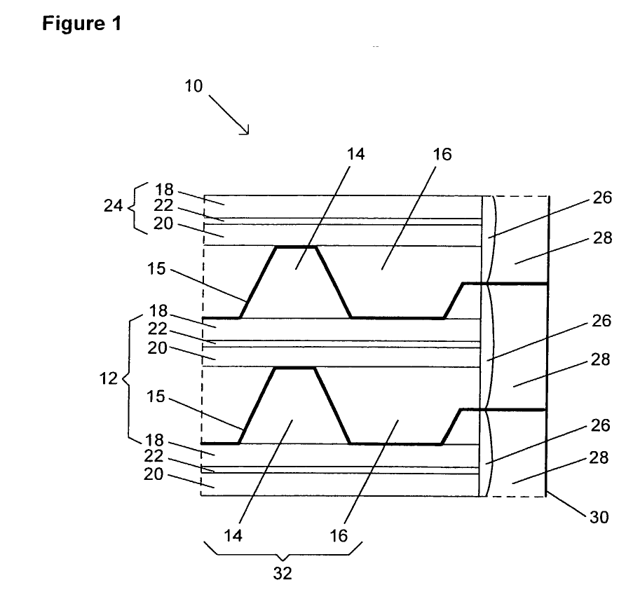

FIG. 1 illustrates a sectional view of a portion of a fuel cell stack 10 which comprises a plurality of fuel cells 12. A corrugated bipolar metal plate 15 is used to separate individual fuel cells 12 as well as provide fuel channels 14 and oxidant channels 16. Fuel channels 14 and oxidant channels 16 are collectively referred to as reactant flow channels 32. Fuel for fuel cell 12 flows through fuel channels 14 to an anode 18. Similarly, an oxidant will flow through oxidant channels 16 to a cathode 20. Interposed between anode 18 and cathode 20 is an ion exchange membrane 22. Anode 18, cathode 20 and ion exchange membrane 22 together form a membrane electrode assembly 24. The electrochemically active area of membrane electrode assembly 24 has catalyst (not shown) disposed at the interface between membrane electrode assembly 24 and each electrode, namely anode 18 and cathode 20. An edge seal 26 seals and protects membrane electrode assembly 24 and the reactant flow regions 32 at the edge of fuel cell 12. Coolant channels 28 are formed along the edge of fuel cell 12 between edge seal 26 and an external seal 30. Edge seal 26 thus fluidly isolates coolant channels 28 from the reactant flow regions 32 and membrane electrode assembly 24.

Liquid coolant can then be directed through coolant channels 28. Non-evaporative conductive cooling by simply directing a coolant adjacent to the active area has a relatively low heat transfer coefficient of 30-1000 W/m²K depending on the coolant used and the geometry of the channel. More efficient cooling can be observed when the coolant is allowed to evaporate. Evaporative cooling has a heat transfer coefficient of approximately 18,000 W/m²K for water. To observe evaporative cooling, an appropriate solvent must first be chosen with a suitable boiling point for the working temperatures of the fuel cell. For example, water with a boiling point of 100° C. may be a suitable coolant in many fuel cells where the operating temperature is greater than 100° C. Further, the efficiency of the evaporative cooling will be affected by the flow rate of coolant through coolant channels 28. If the coolant flow rate is too great, little or no evaporative cooling will be observed. Conversely, if the coolant flow rate is too small, most or all of the coolant may evaporate near the coolant inlet thereby cooling only the region of the fuel cell near the coolant inlet and not a similar region near the coolant outlet. This may result in a large temperature gradient across the fuel cell that adversely affects fuel cell performance.

Additional control over the evaporative properties of the coolant can be obtained by, for example, varying the pressure in the coolant channel. As a result of the varied pressure, the boiling point of the coolant will similarly be altered. This may allow, for example, evaporative cooling when the fuel cell is operated at a greater range of temperatures or the use of different coolants.

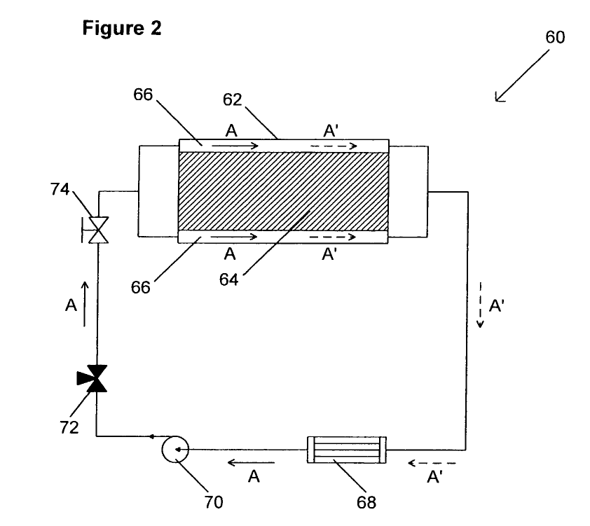

In an embodiment, the evaporated coolant exhausted from the fuel cell may subsequently be condensed and recirculated back to the fuel cell to form an evaporation-condensation cycle and thereby reduce the amount of coolant needed for the continuous operation of the fuel cell. FIG. 2 is a simplified schematic of a coolant system 60 illustrating the recirculation of condensed coolant back to the fuel cell. A fuel cell 62 comprises a conventional active area 64 and coolant channels 66 oriented along the edge of the active area 64. Arrows A and A′ indicate the direction of flow of coolant through the coolant system. The direction of flow of liquid coolant is indicated by arrows A and that of evaporated coolant is indicated by dashed arrows A′. As the coolant (not shown) flows through coolant channels 66, at least some of the coolant evaporates. While not all of the coolant will necessarily evaporate within coolant channel 66, the phrase “evaporated coolant” as used herein refers to coolant completely in the vapor phase as well as partially evaporated coolant. A coolant condenser 68 is fluidly connected to coolant channels 66 wherein the evaporated coolant condenses back to the liquid coolant. Coolant condenser 68 may be, for example a condensing coil or any other conventional means to condense an evaporated coolant. A pump 70, fluidly connected to both coolant condenser 68 and coolant channels 66 recirculates the liquid coolant back to fuel cell 62. Pump 70 may also be used to vary the pressure either above or below ambient pressure in the coolant channels and thereby vary the boiling point of the coolant. The pressure will be a function of the pump speed. The use of a throttle valve 74 and connection to a constant pressure source provides greater control and reliability in varying the pressure as performed by pump 70. For example, gaseous bubbles in the liquid coolant may otherwise affect the efficiency by which pump 70 is able to vary the pressure in the coolant channels. In FIG. 2, the constant pressure source is provided by the external atmosphere through connector 72.

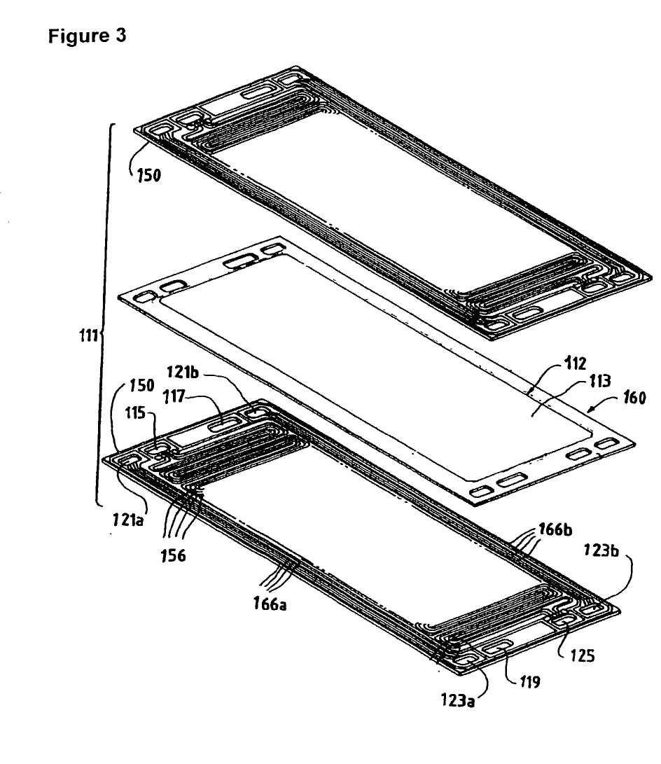

FIGS. 3-5 discussed below, describe in greater detail representative fuel cells and fuel cell stacks in which the present invention may be employed.

FIG. 3 is an exploded isometric view of a portion of a fuel cell stack showing a repeating unit 111. A membrane assembly plate 160 is interposed between two substantially identical fluid flow field plates 150. Membrane assembly plate 160 includes a membrane electrode assembly 112. An electrochemically active area 113 of membrane electrode assembly 112 has electrocatalyst (not shown) disposed at both the membrane-electrode interfaces.

The upper surface of each of fluid flow field plates 150 has a plurality of open-faced channels 156 formed in it. The channels traverse a portion of plate 150 which superposes electrochemically active area 113. Channels 156 extend from oxidant stream inlet manifold opening 115 to oxidant stream outlet manifold opening 125 to direct an oxidant stream in fluid communication with the cathode on the lower face of adjacent membrane electrode assembly 112. The lower surface of each of fluid flow field plate 150 also has similar open-faced channels in it (not shown), extending from fuel stream inlet manifold opening 117 to fuel stream outlet manifold opening 119, to direct a fuel stream in fluid communication with the anode on the upper face of the adjacent membrane electrode assembly. The fuel stream channels also traverse a portion of plate 150 that superposes electrochemically active area 113.

Both surfaces of each plate 150 are provided with coolant channels 166a, 166b which extend from coolant inlet manifold openings 121a, 121b to coolant outlet manifold openings 123a, 123b respectively, and are disposed in the portion of plate 150 which does not superpose electrochemically active area 113. In other words, coolant channels 166a, 166b are adjacent to or along an edge of electrochemically active area 113. Evaporative edge cooling may thus be employed in the fuel cell illustrated in FIG. 3.

Plates 150 are substantially fluid impermeable and in the assembled fuel cell stack the fuel, oxidant and coolant manifolds and passages are typically fluidly isolated from one another by various sealing mechanisms.

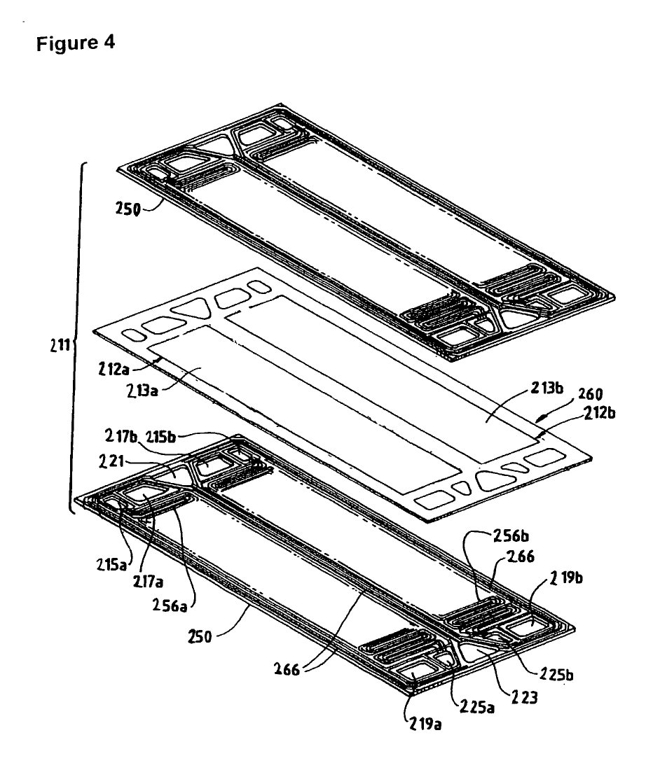

Additional coolant channels, with or without evaporative cooling, may be introduced through the middle of the active area to reduce the temperature gradient across the active area. This embodiment is illustrated in FIG. 4.

FIG. 4 is an exploded isometric view of a portion of a fuel cell stack showing a repeating unit 211. A membrane assembly plate 260 is interposed between two substantially identical fluid flow field plates 250. Membrane assembly plate 260 includes two membrane electrode assemblies 212a and 212b juxtaposed in the same plane. Electrochemically active areas 213a, 213b of membrane electrode assemblies 212a, 212b respectively have electrocatalyst (not shown) disposed at both the membrane-electrode interfaces.

The upper surface of each of fluid flow field plates 250 has two sets of open-faced channels 256a, 256b formed in it. Sets of channels 256a, 256b each traverse a portion of plate 250 which superposes electrochemically active area 213a, 213b respectively. Channels 256a extend from oxidant stream inlet manifold opening 215a to oxidant stream outlet manifold opening 225a to direct an oxidant stream in fluid communication with the cathode on the lower face of the adjacent membrane electrode assembly 212a. Similarly channels 256b extend from oxidant stream inlet manifold opening 215b to oxidant stream outlet manifold opening 225b to direct an oxidant stream in fluid communication with the cathode on the lower face of adjacent membrane electrode assembly 212b.

The lower surface of each of fluid flow field plates 250 also has two similar sets of open-faced channels in it (not shown). The first set extends from fuel stream inlet manifold opening 217a to fuel stream outlet manifold opening 219a to direct a fuel stream in fluid communication with the anode on the upper face of the adjacent membrane electrode assembly (not shown) of the next repeating unit. The second set of channels extends from fuel stream inlet manifold opening 217b to fuel stream outlet manifold 219b to direct a fuel stream in fluid communication with the electrode on the upper face of the adjacent membrane electrode assembly. Thus, the first and second sets of fuel stream channels traverse a portion of plate 250 which superposes electrochemically active areas 213a, 213b respectively.

Both surfaces of each plate 250 are provided with coolant channels 266 which extend from coolant inlet manifold opening 221 to coolant outlet manifold opening 223 and are disposed in the portion of the plate 250 which does not superpose electrochemically active areas 213a, 213b. In the illustrated embodiment, evaporative cooling is employed in all of the coolant channels. If a mixture of evaporative and non-evaporative cooling is desired, additional coolant inlet manifold openings would be needed. Plates 250 are substantially fluid impermeable and the fuel, oxidant and coolant manifolds and passages are typically fluidly isolated from one another by various sealing mechanisms.

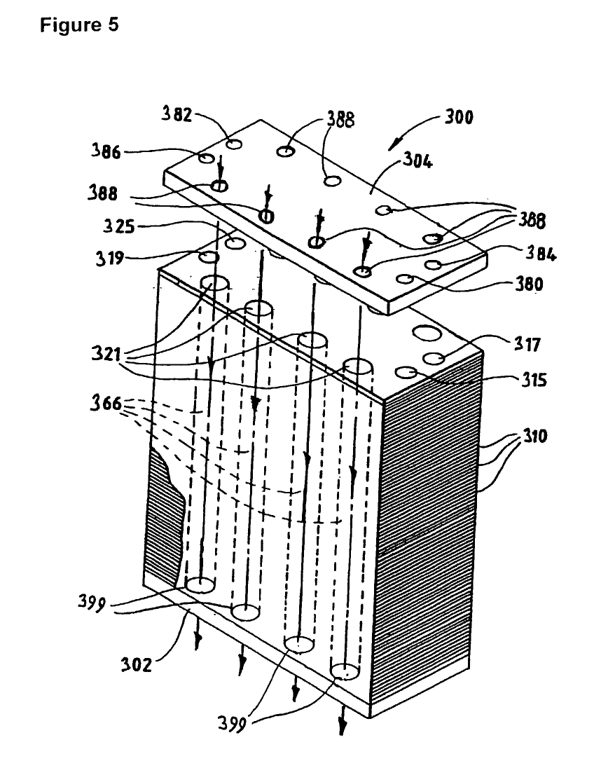

In the embodiments as illustrated in FIGS. 1-4 described above, coolant channels extend substantially parallel to the major planar surfaces of the plate and to the major planar surfaces of the membrane electrode assemblies. FIG. 5 shows a simplified schematic isometric view of a fuel cell stack 300 in which coolant channels extend through the thickness of each separator layer from one of its major planar surfaces to the other, the coolant channels thus extending substantially perpendicular to its major planar surfaces.

Fuel cell stack 300 includes end plate assemblies 302 and 304 and a plurality of fuel cell assemblies 310 interposed between end plate assemblies 302, 304. Each repeating unit fuel cell assembly 310 includes a single fluid flow field plate and a membrane electrode assembly (detail not shown). The upper surface of each fluid flow field plate of repeating units 310 has at least one open-faced oxidant stream channel formed in it which traverses a portion of the plate extending from oxidant stream inlet manifold opening 315 to oxidant stream outlet manifold opening 325. The lower surface of each of fluid flow field plates 310 also has similar open-faced channels in it, extending from fuel stream inlet manifold opening 317 to fuel stream outlet manifold opening 319. In the assembled stack, the aligned reactant fluid manifold openings form internal manifolds or headers for supply and exhaust of reactants to the channels in the fluid flow field plates. The fluid reactant streams are supplied to and exhausted from these internal manifolds via oxidant inlet and outlet ports 380 and 382 respectively, and fuel inlet and outlet ports 384 and 386 respectively, in end plate assembly 304.

In the illustrated fuel cell stack 300, the surfaces of the fluid flow field plates 310 do not have coolant channels formed therein. Aligned opening 321 extending through the thickness of the repeating units 310 form interconnected coolant channels 366 through which a coolant is directed substantially perpendicular to the major planar surfaces of the stacked assemblies 310. Thus, coolant channels extend through each separator layer, from a coolant inlet on one of its major planar surfaces to a coolant outlet on the other major planar surface, and are disposed in the portion of the layer that does not superpose the electrochemically active area of the adjacent membrane electrode assemblies. In the illustrated embodiment, the direction of flow of coolant in coolant channels 366 is co-current though the direction of flow could vary from that illustrated.

The coolant is supplied to channels 366 via coolant inlet ports, 388 in end plate assembly 304 and exhausted from coolant outlet ports, 399 in end plate assembly 302.

Plates 310 are substantially fluid impermeable and in the assembled fuel cell stack, the fuel, oxidant and coolant manifolds and passages are typically fluidly isolated from one another by various conventional sealing mechanisms (not shown).

In the embodiments illustrated in FIGS. 1-5 and described above, preferably the fluid flow field plates are highly thermally conductive so that heat is conducted laterally through the plate from the region superposing the electrochemically active area of the membrane electrode assemblies to the region having coolant channels formed therein.

In practice, the shape and dimensions of membrane electrode assemblies and the configuration of the reactant and coolant channels are selected so that, in operation, adequate cooling is obtained across the entire electrochemically active area of each fuel cell in a fuel cell stack. The preferred design depends on many factors including preferred operating conditions, the thermal conductivity of the separator layer materials, the nature of the coolant, and the power and voltage requirements.

While particular steps, elements, embodiments and applications of the present invention have been shown and described, it will be understood, of course, that the invention is not limited thereto since modifications may be made by persons skilled in the art, particularly in light of the foregoing teachings. It is therefore contemplated by the appended claims to cover such modifications as incorporate those steps or elements that come within the spirit and scope of the invention.

What is claimed is:

1. A method for cooling a fuel cell, the fuel cell comprising a coolant channel situated along an edge of an electrode of the fuel cell, the method comprising the steps of:
(a) determining an operating temperature for the fuel cell;
(b) selecting a liquid coolant for use with the coolant channel wherein the liquid coolant has a boiling point below the operating temperature of the fuel cell;
(c) operating the fuel cell;
(d) directing the liquid coolant into the coolant channel such that the coolant evaporates from the heat generated by the fuel cell;
(e) feeding the evaporated coolant through a coolant condenser; and
(f) recirculating the condensed coolant back into the coolant channel.

2. The method of claim 1 wherein the coolant is water.

3. The method of claim 1 wherein the coolant condenser is a condensing coil.

4. The method of claim 1 further comprising the step of varying the pressure in the coolant channel to vary the boiling point of the coolant in the coolant channel.

5. The method of claim 4 wherein the pressure of the coolant channel is reduced below ambient pressure.

6. The method of claim 4 wherein both the directing a liquid coolant step and the varying the pressure step are performed with a single pump.

7. A fuel cell having an operating temperature comprising:
(a) a pair of electrodes comprising an electrochemically active area;
(b) a coolant channel situated along an edge of at least one of the electrodes; and
(c) a liquid coolant situated within the coolant channel having a boiling point below the operating temperature of the fuel cell.

8. An electrochemical fuel cell system comprising:
(a) a fuel stack comprising at least one fuel cell having an operating temperature, the fuel cell comprising:
(1) a pair of electrodes comprising an electrochemically active area;
(2) a coolant channel situated along an edge of at least one of the electrodes; and
(3) a liquid coolant situated within the coolant channel having a boiling point below the operating temperature of the fuel cell;
the fuel cell stack further comprising a coolant inlet port and a coolant outlet port both fluidly connected to the coolant channel;
(b) a coolant condenser fluidly connected to the coolant outlet port; and
(c) a pump fluidly connected to both the coolant condenser and the coolant inlet port for recirculating the coolant through the coolant channel.

9. The electrochemical fuel cell system of claim 8 wherein the coolant is water.

10. The electrochemical fuel cell system of claim 8 wherein the coolant condenser is a condensing coil.

11. The electrochemical fuel cell system of claim 8 wherein the coolant channel is oriented substantially parallel to the active area in the fuel cell in the fuel cell stack.

12. The electrochemical fuel cell system of claim 8 wherein the coolant channel is oriented substantially perpendicularly to the active area in the fuel cell in the fuel cell stack.

13. The electrochemical fuel cell system of claim 8 further comprising:
(a) a connector to a constant pressure source fluidly connected to the pump; and
(b) a throttle valve fluidly connected to the connector and the coolant inlet port.
